(19) United States
(12) Patent Application Publication
(10) Pub. No.: US 2026/0172538 A1
(43) Pub. Date: Jun. 18, 2026

(54) DISPLAY APPARATUS

(71) Applicant: AUO Corporation, Hsinchu City (TW)

(72) Inventors: YuTang Tsai, Hsinchu City (TW); Jia-Long Wu, Hsinchu City (TW); Chin-An Lin, Hsinchu City (TW); Yi-Ting Liaw, Hsinchu City (TW); Kun-Cheng Tien, Hsinchu City (TW)

(73) Assignee: AUO Corporation, Hsinchu City (TW)

(21) Appl. No.: 19/238,546

(22) Filed: Jun. 16, 2025

(30) Foreign Application Priority Data
Dec. 13, 2024 (TW) 113148741

(51) Int. Cl. H04N 13/32; H04N 13/315

(52) U.S. Cl. CPC H04N 13/32; H04N 13/315; H04N 2213/001

(57) ABSTRACT

Provided is a display apparatus includes a display panel and a transparent display panel. The transparent display panel is disposed in front of the display panel. The display panel is separated from the transparent display panel by a distance. Within a frame time of the display apparatus, the display panel displays a first image, the transparent display panel displays a second image, and the first image and the second image are matched to provide a real depth image. The frame time includes a plurality of sub-frame times in time sequence. The display panel displays a plurality of sub-images in the sub-frame times, respectively. The sub-images are different from each other, and the sub-images are capable of being superimposed to form the first image within the frame time. In addition, other display apparatus is also provided.

### CROSS-REFERENCE TO RELATED APPLICATION

This application claims the priority benefit of Taiwan application serial no. 113148741, filed on Dec. 13, 2024. The entirety of the above-mentioned patent application is hereby incorporated by reference herein and made a part of this specification.

### BACKGROUND

### Technical Field

The disclosure relates to a display apparatus.

### Description of Related Art

In recent years, with the advancement of display technology, users have increasingly higher requirements for display quality (e.g., image resolution, color saturation, etc.). In addition to high image resolution and high color saturation, in some applications, users also hope that the display may display three-dimensional images.

Current three-dimensional image display technologies may be broadly divided into stereoscopic 3D displays that require users to wear special glasses and naked eyes type (or namely auto-stereoscopic) 3D displays that may be viewed directly with the naked eye. Conventional naked eye 3D displays have the problem of causing dizziness to users. Thus, others have proposed different types of naked eye 3D displays, such as multi-layer displays. A multi-layer display includes a display panel and a transparent display panel set in front of the display panel, where there exists an actual distance between the display panel and the transparent display panel. Since multi-layer displays have true depth properties, they do not encounter the problem of causing dizziness to users. However, the display panel and the transparent display panel of the multi-layer display overlap with each other, which easily produces moiré pattern, seriously affecting the viewing experience of users.

### SUMMARY

An embodiment of the disclosure provides a display apparatus that may suppress moiré pattern.

Another embodiment of the disclosure provides a display apparatus that may suppress moiré pattern correspondingly according to changes in the distance between the transparent display panel and the display panel.

Yet another embodiment of the disclosure provides a display apparatus that may suppress moiré pattern.

A display apparatus of an embodiment of the disclosure includes a display panel and a transparent display panel. The transparent display panel is disposed in front of the display panel. The display panel is separated from the transparent display panel by a distance. Within a frame time of the display apparatus, the display panel displays a first image, the transparent display panel displays a second image, and the first image and the second image are matched to provide a real depth image. The frame time includes a plurality of sub-frame times in time sequence. The display panel displays a plurality of sub-images in the sub-frame times, respectively. The sub-images are different from each other, and the sub-images are capable of being superimposed to form the first image within the frame time.

A display apparatus of another embodiment of the disclosure includes a display panel and a transparent display panel. The transparent display panel is disposed in front of the display panel. The display panel is separated from the transparent display panel by a distance. This distance is adjustable. Within a first frame time of the display apparatus, the display panel displays a first image, the transparent display panel displays a second image, and the first image and the second image are matched to provide a first real depth image. The first frame time includes a plurality of first sub-frame times in time sequence, the display panel displays a plurality of first sub-images respectively at the plurality of first sub-frame times, the plurality of first sub-images are different from each other, and the plurality of first sub-images are capable of being superimposed to form the first image within the first frame time. Within a second frame time of the display apparatus, the display panel displays a third image, the transparent display panel displays a fourth image, and the third image and the fourth image are matched to provide a second real depth image. The second frame time includes a plurality of second sub-frame times in time sequence, the display panel displays a plurality of second sub-images respectively at the plurality of second sub-frame times, the plurality of second sub-images are different from each other, and the plurality of second sub-images are capable of being superimposed to form the third image within the second frame time. The second frame time is before or after the first frame time, and a time length of the first frame time is substantially equal to a time length of the second frame time. Within the first frame time, the distance between the display panel and the transparent display panel is a first distance. Within the second frame time, the distance between the display panel and the transparent display panel is a second distance, and the second distance is less than the first distance. A quantity of the second sub-images displayed by the display panel within the second frame time is greater than a quantity of the first sub-images displayed by the display panel within the first frame time.

A display apparatus of another embodiment of the disclosure includes a display panel, a transparent display panel, and an electronic control element. The transparent display panel is disposed in front of the display panel. The display panel is separated from the transparent display panel by a distance. The electronic control element is disposed between the transparent display panel and the display panel. Within a frame time of the display apparatus, the display panel displays a first image, the transparent display panel displays a second image, and the first image and the second image are matched to provide a real depth image. The frame time includes a plurality of sub-frame times in time sequence, the electronic control element displays a plurality of scattered images at the plurality of sub-frame times, respectively, and the scattered images have different spatial distributions in the electronic control element.

### BRIEF DESCRIPTION OF THE DRAWINGS

FIG. 1A to FIG. 1C are cross-sectional schematic diagrams of a display apparatus 10 according to an embodiment of the disclosure.

FIG. 2 is a cross-sectional schematic diagram of the display apparatus 10 according to an embodiment of the disclosure.

FIG. 3A to FIG. 3C are exploded three-dimensional schematic diagrams of the display apparatus 10 according to an embodiment of the disclosure.

FIG. 4 is an exploded three-dimensional schematic diagram of the display apparatus 10 according to an embodiment of the disclosure.

FIG. 5A to FIG. 5C are cross-sectional schematic diagrams of a display apparatus 10A according to another embodiment of the disclosure.

FIG. 6 is a cross-sectional schematic diagram of the display apparatus 10A according to another embodiment of the disclosure.

FIG. 7A to FIG. 7C are exploded three-dimensional schematic diagrams of the display apparatus 10A according to another embodiment of the disclosure.

FIG. 8 is an exploded three-dimensional schematic diagram of the display apparatus 10A according to another embodiment of the disclosure.

FIG. 9A to FIG. 9B are cross-sectional schematic diagrams of a display apparatus 10B according to yet another embodiment of the disclosure.

FIG. 10 is a cross-sectional schematic diagram of the display apparatus 10B according to yet another embodiment of the disclosure.

FIG. 11A to FIG. 11B are exploded three-dimensional schematic diagrams of the display apparatus 10B according to yet another embodiment of the disclosure.

FIG. 12 is an exploded three-dimensional schematic diagram of the display apparatus 10B according to yet another embodiment of the disclosure.

FIG. 13A to FIG. 13B are cross-sectional schematic diagrams of a display apparatus 10C according to still another embodiment of the disclosure.

FIG. 14 is a cross-sectional schematic diagram of the display apparatus 10C according to still another embodiment of the disclosure.

FIG. 15A to FIG. 15B are exploded three-dimensional schematic diagrams of the display apparatus 10C according to still another embodiment of the disclosure.

FIG. 16 is an exploded three-dimensional schematic diagram of the display apparatus 10C according to still another embodiment of the disclosure.

FIG. 17A to FIG. 17C are cross-sectional schematic diagrams of the display apparatus 10C according to still another embodiment of the disclosure.

FIG. 18 is a cross-sectional schematic diagram of the display apparatus 10C according to still another embodiment of the disclosure.

FIG. 19A to FIG. 19C are exploded three-dimensional schematic diagrams of the display apparatus 10C according to still another embodiment of the disclosure.

FIG. 20 is an exploded three-dimensional schematic diagram of the display apparatus 10C according to still another embodiment of the disclosure.

FIG. 21A to FIG. 21C are cross-sectional schematic diagrams of a display apparatus 10D according to an embodiment of the disclosure.

FIG. 22 is a cross-sectional schematic diagram of the display apparatus 10D according to an embodiment of the disclosure.

FIG. 23A to FIG. 23C are exploded three-dimensional schematic diagrams of the display apparatus 10D according to an embodiment of the disclosure.

FIG. 24 shows the display effect superimposed by the display apparatus 10D in a plurality of sub-frame times t1, t2 and t3 (i.e., one frame time T) corresponding to FIG. 23A, FIG. 23B, and FIG. 23C.

### DESCRIPTION OF THE EMBODIMENTS

References of the exemplary embodiments of the disclosure are to be made in detail. Examples of the exemplary embodiments are illustrated in the drawings. If applicable, the same reference numerals in the drawings and the descriptions indicate the same or similar parts.

It should be understood that when an element such as a layer, a film, an area, or a substrate is indicated to be “on” another element or “connected to” another element, it may be directly on another element or connected to another element, or an element in the middle may exist. In contrast, when an element is indicated to be “directly on another element” or “directly connected to” another element, an element in the middle does not exist. As used herein, “to connect” may indicate to physically and/or electrically connect. Furthermore, “to electrically connect” or “to couple” may also be used when other elements exist between two elements.

The usages of “approximately”, “similar to”, or “substantially” indicated throughout the specification include the indicated value and an average value having an acceptable deviation range, which is a certain value confirmed by people skilled in the art, and is a certain amount considered the discussed measurement and measurement-related deviation (that is, the limitation of measurement system). For example, “approximately” may indicate to be within one or more standard deviations of the indicated value, or being within ±30%, ±20%, ±10%, ±5%. Furthermore, the usages of “approximately”, “similar to”, or “substantially” indicated throughout the specification may refer to a more acceptable deviation scope or standard deviation depending on optical properties, etching properties, or other properties, and all properties may not be applied with one standard deviation.

Unless otherwise defined, all terms (including technical and scientific terms) used herein have the same meaning as that commonly understood by one of ordinary skill in the art to which this disclosure belongs. It should be further understood that terms such as those defined in commonly used dictionaries should be construed as having meanings consistent with their meanings in the context of the related art and the disclosure, and are not to be construed as idealized or excessive formal meaning, unless expressly defined as such herein.

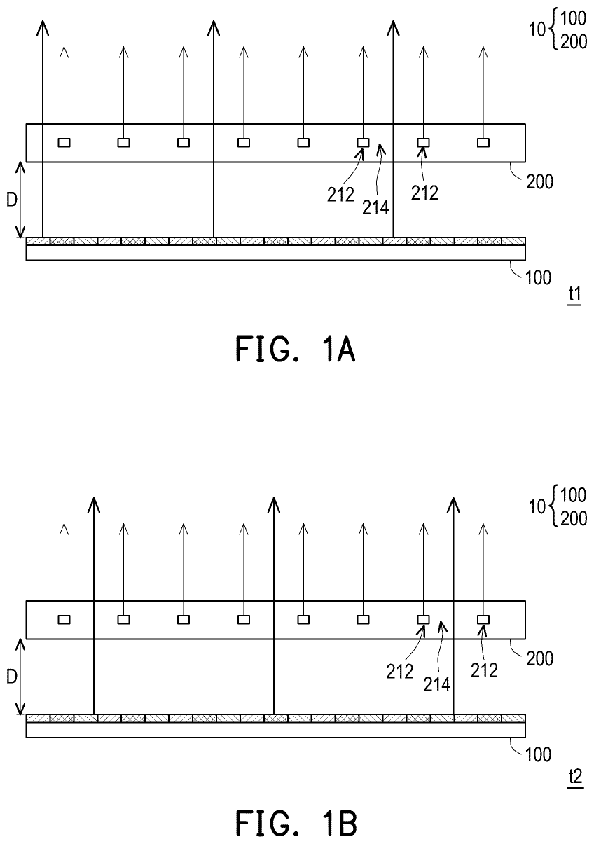

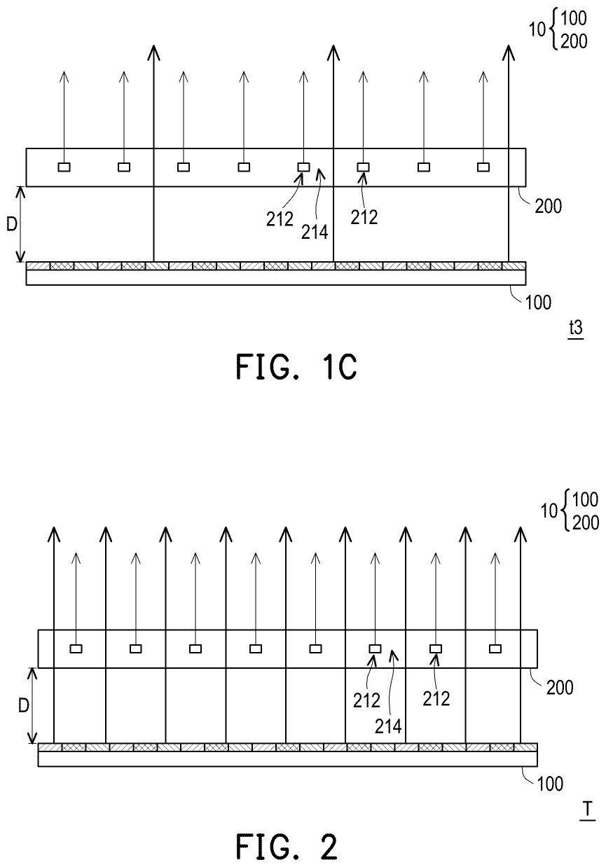

FIG. 1A to FIG. 1C are cross-sectional schematic diagrams of a display apparatus 10 according to an embodiment of the disclosure. Specifically, FIG. 1A to FIG. 1C show the operating status of the display apparatus 10 in a sub-frame time t1, a sub-frame time t2, and a sub-frame time t3, respectively, where the sub-frame time t1, the sub-frame time t2, and the sub-frame time t3 proceed in time sequence within the same frame time T of the display apparatus 10. FIG. 2 is a cross-sectional schematic diagram of the display apparatus 10 according to an embodiment of the disclosure. Specifically, FIG. 2 shows the display effect superimposed by the display apparatus 10 in a plurality of sub-frame times t1, t2, and t3 (i.e., one frame time T) corresponding to FIG. 1A, FIG. 1B and FIG. 1C.

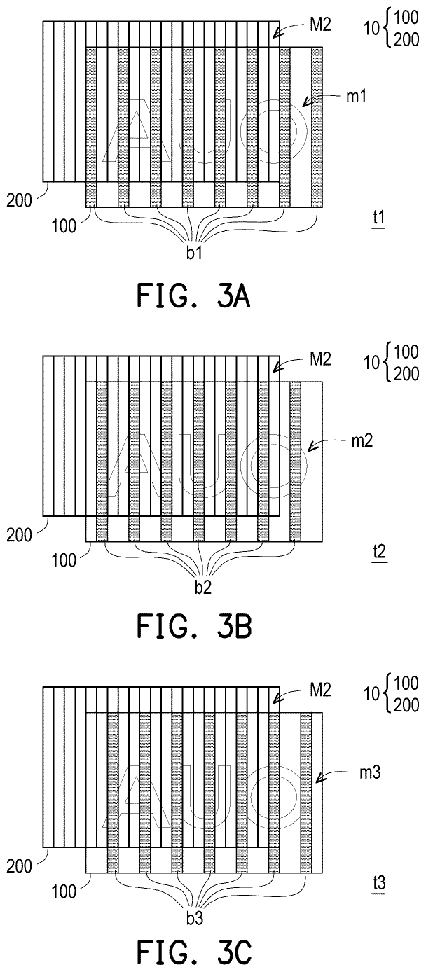

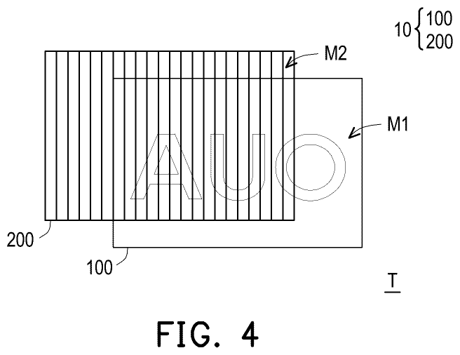

FIG. 3A to FIG. 3C are exploded three-dimensional schematic diagrams of the display apparatus 10 according to an embodiment of the disclosure. Specifically, FIG. 3A to FIG. 3C show the operating status of the display apparatus 10 in the sub-frame time t1, the sub-frame time t2, and the sub-frame time t3, respectively, where the sub-frame time t1, the sub-frame time t2, and the sub-frame time t3 proceed in time sequence within the same frame time T of the display apparatus 10. FIG. 4 is an exploded three-dimensional schematic diagram of the display apparatus 10 according to an embodiment of the disclosure. Specifically, FIG. 4 shows the display effect superimposed by the display apparatus 10 in a plurality of sub-frame times t1, t2, and t3 (i.e., one frame time T) corresponding to FIG. 3A, FIG. 3B and FIG. 3C. FIG. 3A, FIG. 3B, FIG. 3C and FIG. 4 correspond to FIG. 1A, FIG. 1B, FIG. 1C and FIG. 2, respectively.

Referring to FIG. 1A to FIG. 4, the display apparatus 10 includes a display panel 100 and a transparent display panel 200. The transparent display panel 200 is disposed in front of the display panel 100. The display panel 100 and the transparent display panel 200 are separated by a distance D. In some embodiments, the display panel 100 may selectively be a non-self-emitting display panel, such as but not limited to: a liquid crystal display panel. The transparent display panel 200 includes a plurality of pixel areas 212 and a plurality of light transmission areas 214 interspersed among the plurality of pixel areas 212. In some embodiments, the transparent display panel 200 is, for example, a micro light-emitting diode transparent display panel, but the disclosure is not limited thereto.

Referring to FIG. 2 and FIG. 4, within one frame time T of the display apparatus 10, the display panel 100 displays a first image M1, and the transparent display panel 200 displays a second image M2. Since the display panel 100 and the transparent display panel 200 are separated by a real distance D, the matching of the first image M1 displayed by the display panel 100 with the second image M2 displayed by the transparent display panel 200 may provide a real depth image. After the real depth image is received by human eyes, the brain may perceive a stereoscopic image.

For example, in some embodiments, the first image M1 displayed by the display panel 100 located at the rear may be a baseball glove image (not shown), and the second image M2 displayed by the transparent display panel 200 located at the front may be a baseball image (not shown). The baseball image displayed by the transparent display panel 200 located at the front may be directly received by human eyes, and the baseball glove image displayed by the display panel 100 located at the rear may also be received by human eyes after passing through the light transmission areas 214 of the transparent display panel 200, thereby enabling the brain to perceive a three-dimensional image (e.g., an image of a baseball glove catching a ball).

Referring to FIG. 3A, FIG. 3B, FIG. 3C and FIG. 4, one frame time T of the display apparatus 10 includes a plurality of sub-frame times t1, t2, and t3 in time sequence. One frame time T equals the sum of the plurality of sub-frame times t1, t2, and t3. The display panel 100 displays a plurality of sub-images m1, m2, and m3, respectively, in the plurality of sub-frame time t1, t2, and t3 of the same frame time T. Specifically, the plurality of sub-images m1, m2, and m3 are different from each other, and the plurality of sub-images m1, m2, and m3 may be superimposed to form the first image M1 within the frame time T.

It is worth mentioning that the first image M1 to be displayed by the display panel 100 within one frame time T is divided into different sub-images m1, m2, and m3, and the plurality of sub-images m1, m2, and m3 are displayed respectively in the plurality of sub-frame times t1, t2, and t3 of the frame time T. Thus, at various locations of the display apparatus 10, the differences between the spatial frequencies of different sub-images m1, m2, and m3 and the spatial frequency of the same second image M2 of the transparent display panel 200 are different, meaning that the difference in spatial frequency between the transparent display panel 200 and the display panel 100 is not fixed, which suppresses the moiré pattern between the display panel 100 and the transparent display panel 200. In other words, by increasing the scanning frequency of the display panel 100, the difference in spatial frequency between the display panel 100 and the transparent display panel 200 may be changed over time, effectively suppressing the moiré pattern.

Referring to FIG. 3A, FIG. 3B and FIG. 3C, in some embodiments, each sub-image m1/m2/m3 has a black pattern b1/b2/b3, and the plurality of black patterns b1, b2, and b3 of the plurality of sub-images m1, m2, and m3 have different spatial distributions in the display panel 100. For example, in some embodiments, the black pattern b1/b2/b3 of each sub-image m1/m2/m3 may include a plurality of black stripes separated from each other, and the plurality of black stripes of the plurality of black patterns b1, b2, and b3 of the plurality of sub-images m1, m2, and m3 are misaligned with each other. However, the disclosure is not limited thereto. In other embodiments, the plurality of sub-images m1, m2, and m3 may also be any other type of images, and the disclosure does not impose any limitations.

It is to be noted that the following embodiments use the reference numerals and a part of the contents of the above embodiments, and the same reference numerals are used to denote the same or similar elements, and the description of the same technical contents is omitted. For the description of the omitted part, reference may be made to the above embodiments, and details are not described in the following embodiments.

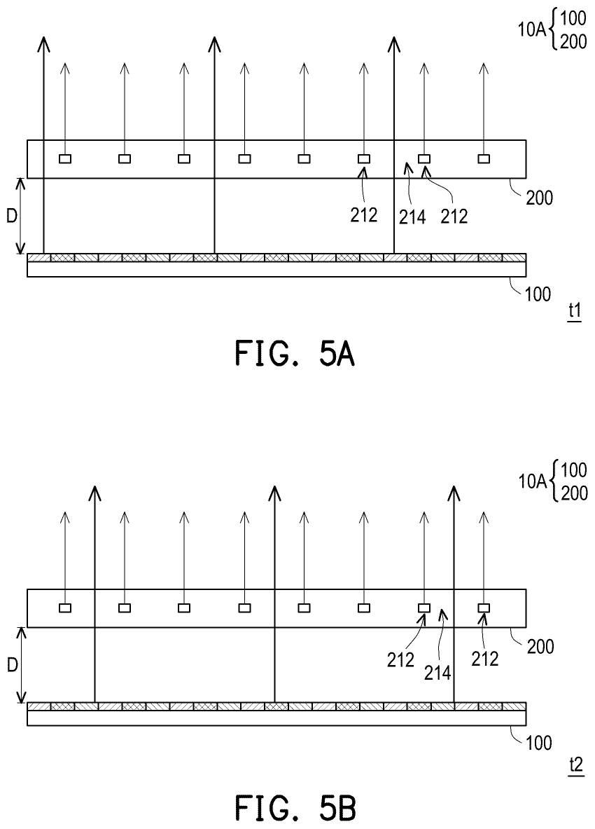

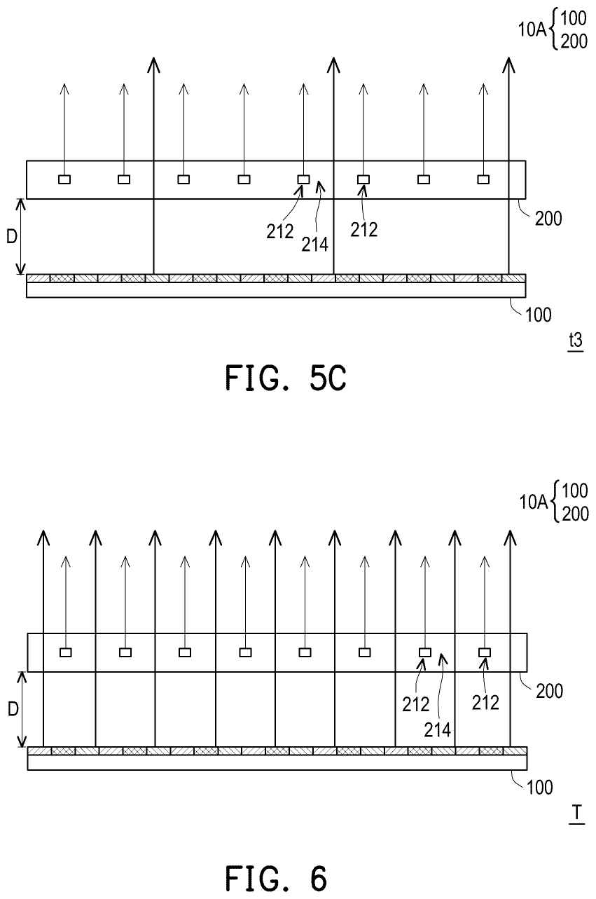

FIG. 5A to FIG. 5C are cross-sectional schematic diagrams of a display apparatus 10A according to another embodiment of the disclosure. Specifically, FIG. 5A to FIG. 5C show the operating status of the display apparatus 10A in the sub-frame time t1, the sub-frame time t2, and the sub-frame time t3, respectively, where the sub-frame time t1, the sub-frame time t2, and the sub-frame time t3 proceed in time sequence within the same frame time T of the display apparatus 10A. FIG. 6 is a cross-sectional schematic diagram of the display apparatus 10A according to another embodiment of the disclosure. Specifically, FIG. 6 shows the superimposed display effect of the display apparatus 10A in the plurality of sub-frame times t1, t2, and t3 (i.e., one frame time T) corresponding to FIG. 5A, FIG. 5B and FIG. 5C.

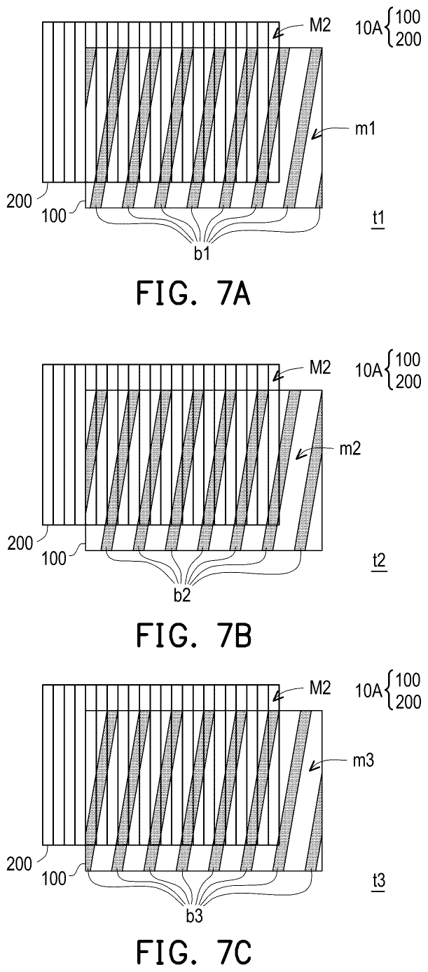

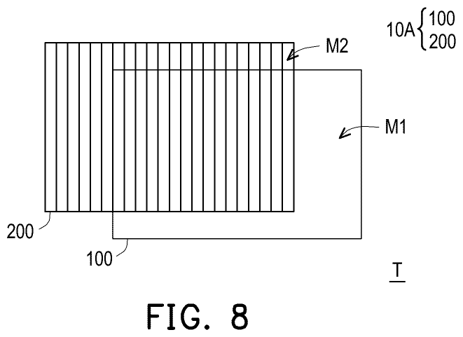

FIG. 7A to FIG. 7C are exploded three-dimensional schematic diagrams of the display apparatus 10A according to another embodiment of the disclosure. Specifically, FIG. 7A to FIG. 7C show the operating status of the display apparatus 10A in the sub-frame time t1, the sub-frame time t2, and the sub-frame time t3, respectively, where the sub-frame time t1, the sub-frame time t2, and the sub-frame time t3 proceed in time sequence within the same frame time T of the display apparatus 10A. FIG. 8 is an exploded three-dimensional schematic diagram of the display apparatus 10A according to another embodiment of the disclosure. Specifically, FIG. 8 shows the superimposed display effect of the display apparatus 10A in the plurality of sub-frame times t1, t2, and t3 (i.e., one frame time T) corresponding to FIG. 7A, FIG. 7B and FIG. 7C. FIG. 7A, FIG. 7B, FIG. 7C and FIG. 8 correspond to FIG. 5A, FIG. 5B, FIG. 5C and FIG. 6, respectively.

The display apparatus 10A of this embodiment is similar to the aforementioned display apparatus 10, with the difference between the two being: the black patterns b1/b2/b3 of their sub-images m1/m2/m3 are different. Referring to FIG. 3A to FIG. 3C, in the previous embodiment, the black patterns b1/b2/b3 of the sub-images m1/m2/m3 of the display panel 100 are a plurality of vertical black stripes. Referring to FIG. 7A to FIG. 7C, in this embodiment, the black patterns b1/b2/b3 of the sub-images m1/m2/m3 of the display panel 100 are a plurality of diagonal black stripes. Similarly, the display apparatus 10A of this embodiment also has the effect of suppressing moiré pattern.

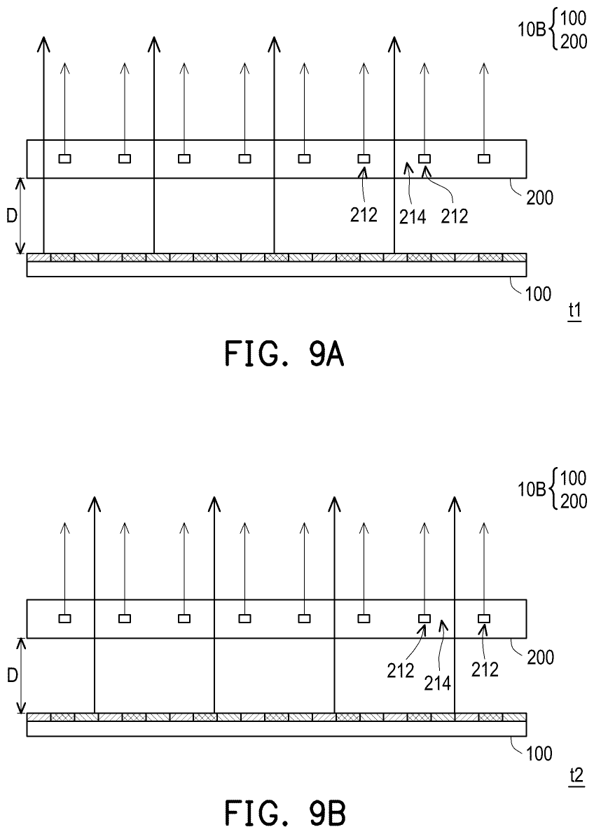

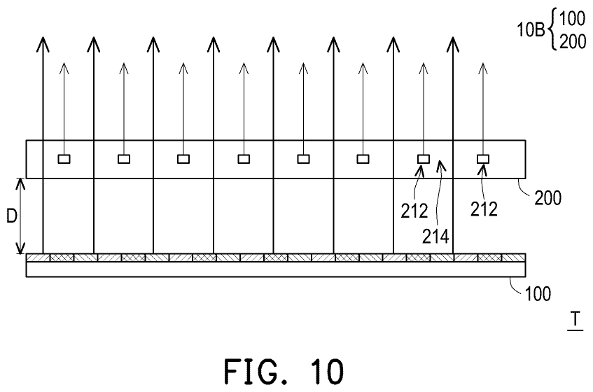

FIG. 9A to FIG. 9B are cross-sectional schematic diagrams of a display apparatus 10B according to yet another embodiment of the disclosure. Specifically, FIG. 9A to FIG. 9B show the operating status of the display apparatus 10B in the sub-frame time t1 and the sub-frame time t2, respectively, where the sub-frame time t1 and the sub-frame time t2 proceed in time sequence within the same frame time T of the display apparatus 10A. One frame time T equals the sum of the plurality of sub-frame times t1 and t2. FIG. 10 is a cross-sectional schematic diagram of the display apparatus 10B according to yet another embodiment of the disclosure. Specifically, FIG. 10 shows the superimposed display effect of the display apparatus 10B in the plurality of sub-frame times t1 and t2 (i.e., one frame time T) corresponding to FIG. 9A and FIG. 9B.

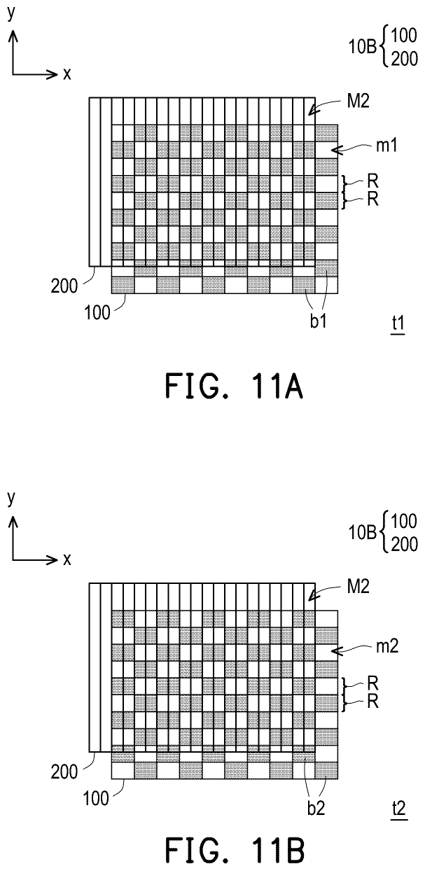

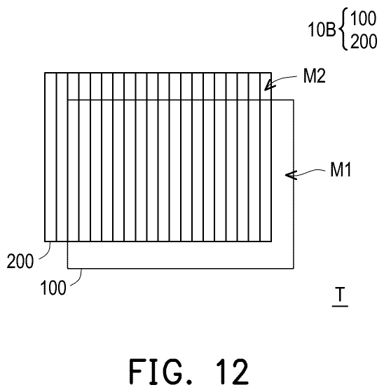

FIG. 11A to FIG. 11B are exploded three-dimensional schematic diagrams of the display apparatus 10B according to yet another embodiment of the disclosure. Specifically, FIG. 11A to FIG. 11B show the operating status of the display apparatus 10B in the sub-frame time t1 and the sub-frame time t2, respectively, where the sub-frame time t1 and the sub-frame time t2 proceed in time sequence within the same frame time T of the display apparatus 10B. FIG. 12 is an exploded three-dimensional schematic diagram of the display apparatus 10B according to yet another embodiment of the disclosure. Specifically, FIG. 12 shows the superimposed display effect of the display apparatus 10B in the plurality of sub-frame times t1 and t2 (i.e., one frame time T) corresponding to FIG. 11A and FIG. 11B. FIG. 11A, FIG. 11B and FIG. 12 correspond to FIG. 9A, FIG. 9B and FIG. 10, respectively.

The display apparatus 10B of this embodiment is similar to the aforementioned display apparatus 10, with the difference between the two being: the black patterns b1/b2/b3 of their sub-images m1/m2/m3 are different. Referring to FIG. 11A to FIG. 11B, specifically, in this embodiment, the black patterns b1/b2 of the sub-images m1/m2 of the display panel 100 include a plurality of black blocks, the plurality of black blocks are arranged into a plurality of black block rows R, the plurality of black blocks in each black block row R are arranged in the first direction x, the plurality of black block rows R are arranged in the second direction y which intersects with the first direction x, and the plurality of black blocks of each black block row R are alternately arranged with the plurality of black blocks of the next black block row R. In short, in this embodiment, the sub-images m1/m2 may be checkerboard images. The plurality of black blocks of the black pattern b1 of the sub-image m1 are misaligned with the plurality of black blocks of the black pattern b2 of the sub-image m2. Similarly, the display apparatus 10B of this embodiment also has the effect of suppressing moiré pattern.

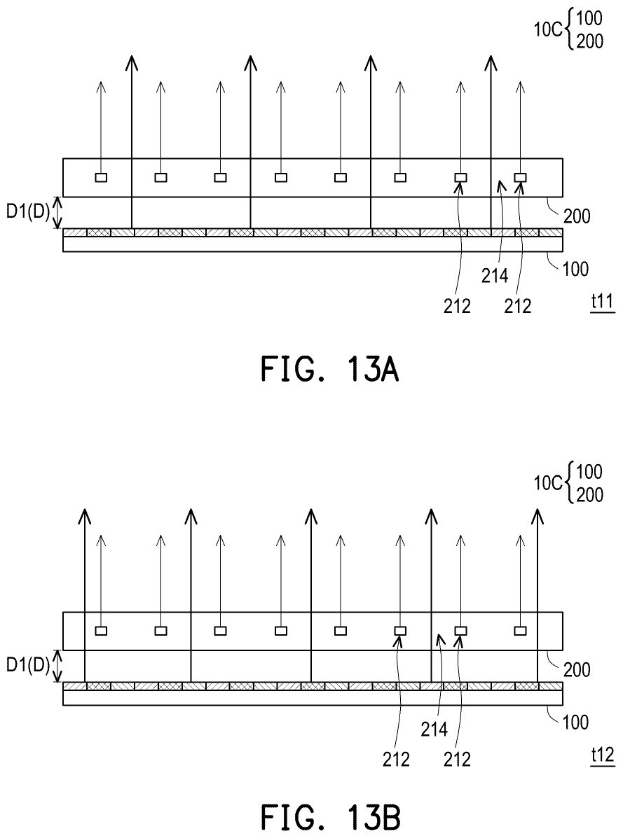

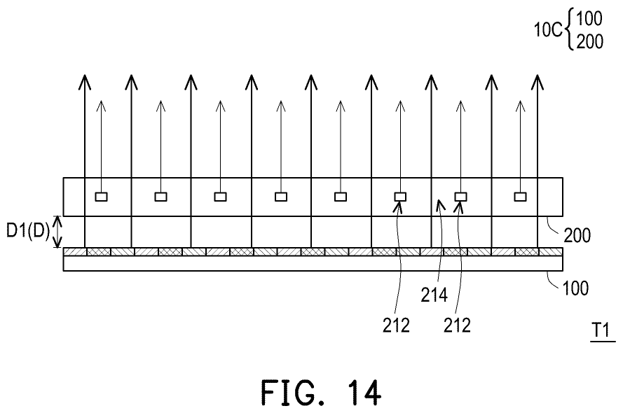

FIG. 13A to FIG. 13B are cross-sectional schematic diagrams of a display apparatus 10C according to still another embodiment of the disclosure. Specifically, FIG. 13A to FIG. 13B show the operating status of the display apparatus 10C in the first sub-frame time t11 and the first sub-frame time t12, respectively, where the first sub-frame time t11 and the first sub-frame time t12 proceed in time sequence within the same first frame time T1 of the display apparatus 10C. The first frame time T1 equals the sum of the plurality of first sub-frame times t11 and t12. FIG. 14 is a cross-sectional schematic diagram of the display apparatus 10C according to still another embodiment of the disclosure. Specifically, FIG. 14 shows the superimposed display effect of the display apparatus 10C in the plurality of first sub-frame times t11 and t12 (i.e., one first frame time T1) corresponding to FIG. 13A and FIG. 13B.

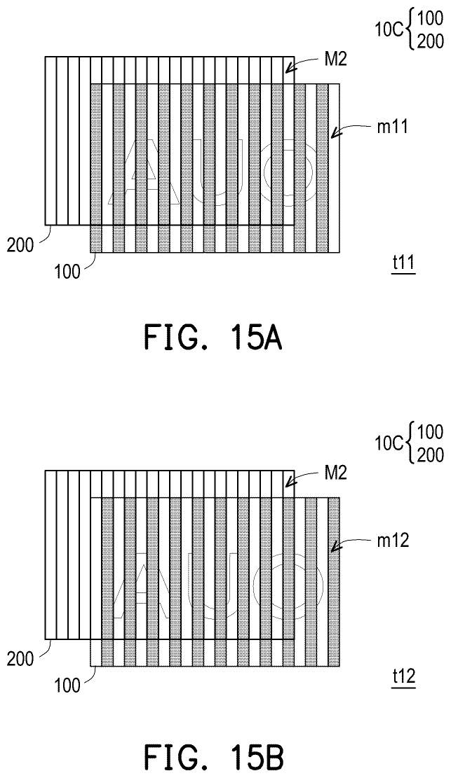

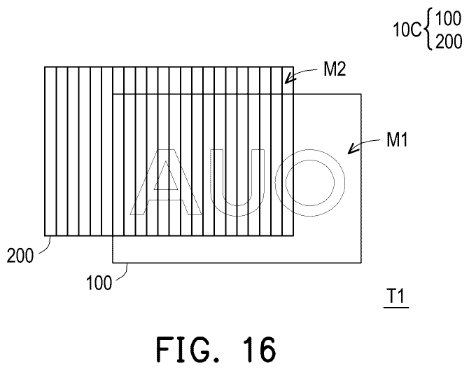

FIG. 15A to FIG. 15B are exploded three-dimensional schematic diagrams of the display apparatus 10C according to still another embodiment of the disclosure. Specifically, FIG. 15A to FIG. 15C show the operating status of the display apparatus 10C in the first sub-frame time t11 and the first sub-frame time t12, respectively, where the first sub-frame time t11 and the first sub-frame time t12 proceed in time sequence within the same first frame time T1 of the display apparatus 10C. FIG. 16 is an exploded three-dimensional schematic diagram of the display apparatus 10C according to still another embodiment of the disclosure. Specifically, FIG. 16 shows the superimposed display effect of the display apparatus 10C in the plurality of first sub-frame times t11 and t12 (i.e., one first frame time T1) corresponding to FIG. 15A to FIG. 15B. FIG. 15A, FIG. 15B and FIG. 16 correspond to FIG. 13A, FIG. 13B and FIG. 14, respectively.

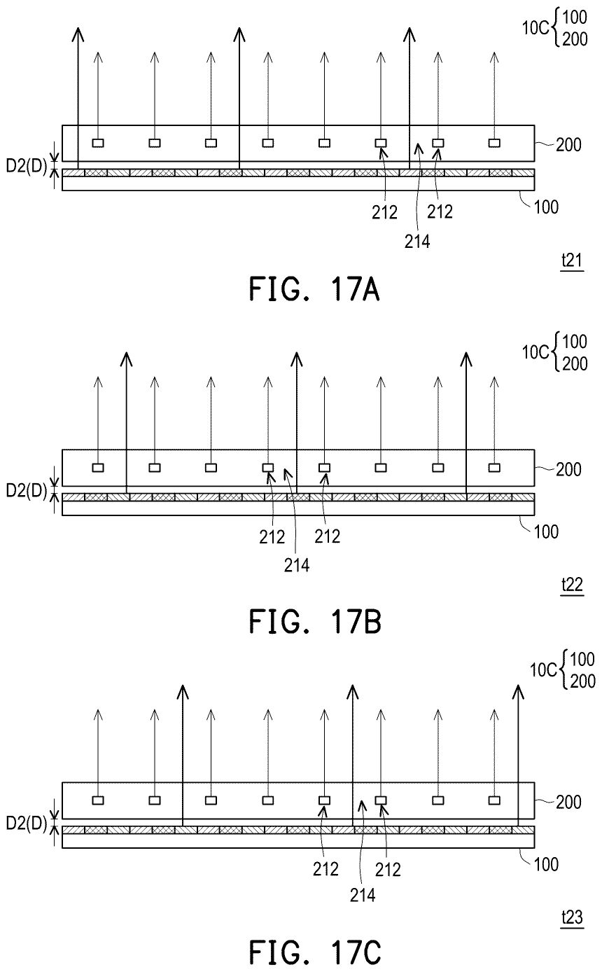

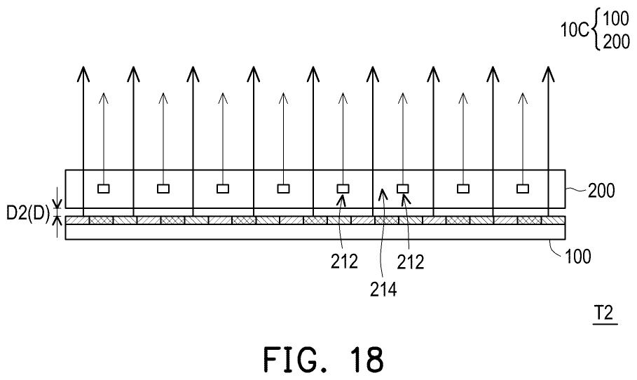

FIG. 17A to FIG. 17C are cross-sectional schematic diagrams of the display apparatus 10C according to still another embodiment of the disclosure. Specifically, FIG. 17A to FIG. 17C show the operating status of the display apparatus 10C in the second sub-frame time t21, the second sub-frame time t22, and the second sub-frame time t23, respectively, where the second sub-frame time t21, the second sub-frame time t22, and the second sub-frame time t23 proceed in time sequence within the same second frame time T2 of the display apparatus 10C. The second frame time T2 equals the sum of plurality of second sub-frame times t21, t22, and t23. FIG. 18 is a cross-sectional schematic diagram of the display apparatus 10C according to still another embodiment of the disclosure. Specifically, FIG. 18 shows the superimposed display effect of the display apparatus 10C in the plurality of second sub-frame times t21, t22, and t23 (i.e., one second frame time T2) corresponding to FIG. 17A, FIG. 17B and FIG. 17C.

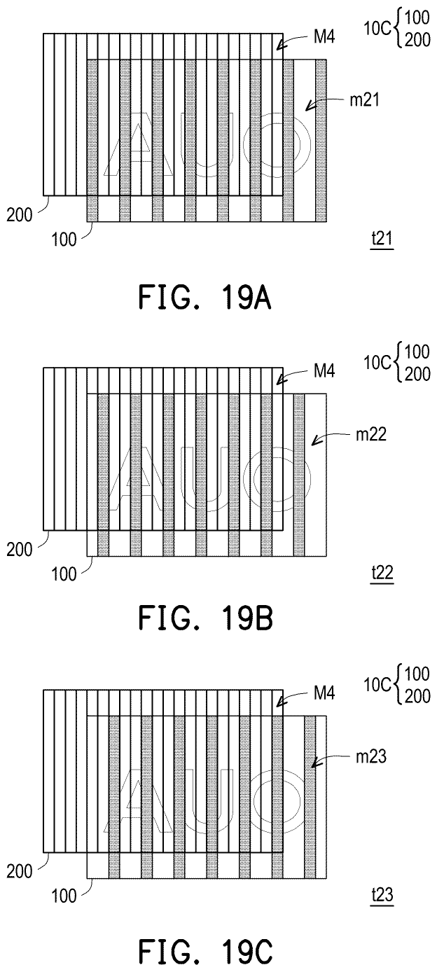

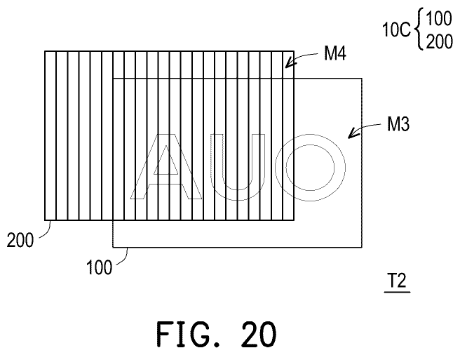

FIG. 19A to FIG. 19C are exploded three-dimensional schematic diagrams of the display apparatus 10C according to still another embodiment of the disclosure. Specifically, FIG. 19A to FIG. 19C show the operating status of the display apparatus 10C in the second sub-frame time t21, the second sub-frame time t22, and the second sub-frame time t23 respectively, where the second sub-frame time t21, the second sub-frame time t22, and the second sub-frame time t23 proceed in time sequence within the same second frame time T2 of the display apparatus 10C. FIG. 20 is an exploded three-dimensional schematic diagram of the display apparatus 10C according to still another embodiment of the disclosure. Specifically, FIG. 20 shows the superimposed display effect of the display apparatus 10C in the plurality of second sub-frame times t21, t22, and t23 (i.e., one second frame time T2) corresponding to FIG. 19A, FIG. 19B and FIG. 19C. FIG. 19A, FIG. 19B, FIG. 19C and FIG. 20 correspond to FIG. 17A, FIG. 17B, FIG. 17C and FIG. 18, respectively.

Referring to FIG. 13A to FIG. 20, the display apparatus 10C of this embodiment is similar to the aforementioned display apparatus 10, with the difference between the two being: in this embodiment, the distance D between the display panel 100 and the transparent display panel 200 of the display apparatus 10C may be adjusted. For example, in some embodiments, spacers (not shown) may be disposed between the display panel 100 and the transparent display panel 200, and the distance D between the display panel 100 and the transparent display panel 200 may be adjusted by increasing or decreasing the quantity of spacers, but the disclosure is not limited thereto. Furthermore, in this embodiment, when the distance D between the display panel 100 and the transparent display panel 200 of the display apparatus 10D is adjusted, the quantity of sub-images displayed by the display panel 100 within one frame time may change accordingly, thereby achieving a better moiré pattern suppression effect. The following examples are illustrated with reference to FIG. 13A to FIG. 20.

Referring to FIG. 13A to FIG. 13B, within the first frame time T1, the distance D between the display panel 100 and the transparent display panel 200 is the first distance D1. Referring to FIG. 13A to FIG. 13B, FIG. 14, FIG. 15A to FIG. 15B and FIG. 16, within the first frame time T1 (i.e., the sum of a plurality of first sub-frame times t12 and t12), the display panel 100 displays the first image M1, the transparent display panel 200 displays the second image M2, and the first image M1 and the second image M2 match with each other to provide a first real depth image. The first frame time T1 includes a plurality of first sub-frame times t11 and t12 in time sequence, the display panel 10C displays a plurality of first sub-images m11 and m12 at the plurality of first sub-frame times t11 and t12, respectively, the plurality of first sub-images m11 and m12 are different from each other, and the plurality of first sub-images m11 and m12 may be added up to form the first image M1 within the first frame time T1.

Referring to FIG. 13A to FIG. 13B, and FIG. 17A to FIG. 17C, the second frame time T2 is before or after the first frame time T1, and the time length of the first frame time T1 is substantially equal to the time length of the second frame time T2. Within the second frame time T2, the distance D between the display panel 100 and the transparent display panel 200 is the second distance D2, and the second distance D2 is smaller than the first distance D1. Referring to FIG. 17A to FIG. 17C, FIG. 18, FIG. 19A to FIG. 19C, and FIG. 20, within the second frame time T2 of the display apparatus 10C, the display panel 100 displays the third image M3, the transparent display panel 200 displays the fourth image M4, and the third image M3 and the fourth image M4 match with each other to provide a second real depth image. The second frame time T2 includes a plurality of second sub-frame times t21, t22, and t23 in time sequence, the display panel 100C displays a plurality of second sub-images m21, m22, and m23 at the plurality of second sub-frame times t21, t22, and t23 respectively, the plurality of second sub-images m21, m22, and m23 are different from each other, and the plurality of second sub-images m21, m22, and m23 may be added up to form the third image M3 within the plurality of second sub-frame times t21, t22, and t23 (i.e., the second frame time T2).

It is worth noting that, in the first frame time T1 and the second frame time T2, the distance D between the display panel 100 and the transparent display panel 200 is different, and the quantity (e.g., 3) of the second sub-images m21, m22, and m23 displayed by the display panel 100C within the second frame time T2 is also different from the quantity (e.g., 2) of the first sub-images m11 and m12 displayed by the display panel 100 within the first frame time T1. The distance D between the display panel 100 and the transparent display panel 200 in the second frame time T2 is smaller than the distance D between the display panel 100 and the transparent display panel 200 in the second frame time T2, and the quantity (e.g., 3) of the second sub-images m21, m22, and m23 displayed by the display panel 100 within the second frame time T2 is greater than the quantity (e.g., 2) of the first sub-images m11 and m12 displayed by the display panel 100 within the first frame time T1.

In other words, if the second frame time T2 is after the first frame time T1, and the distance D between the display panel 100 and the transparent display panel 200 becomes smaller (i.e., changing from the larger first distance D1 to the smaller second distance D2), the quantity of sub-images divided within the frame time of the same time length increases; if the second frame time T2 is before the first frame time T1, meaning the distance D between the display panel 100 and the transparent display panel 200 becomes larger (i.e., changing from the smaller second distance D2 to the larger first distance D1), the quantity of sub-images divided within the frame time of the same time length decreases. Thereby, the display apparatus 10C may better suppress moiré pattern in response to changes in the distance D between the display panel 100 and the transparent display panel 200.

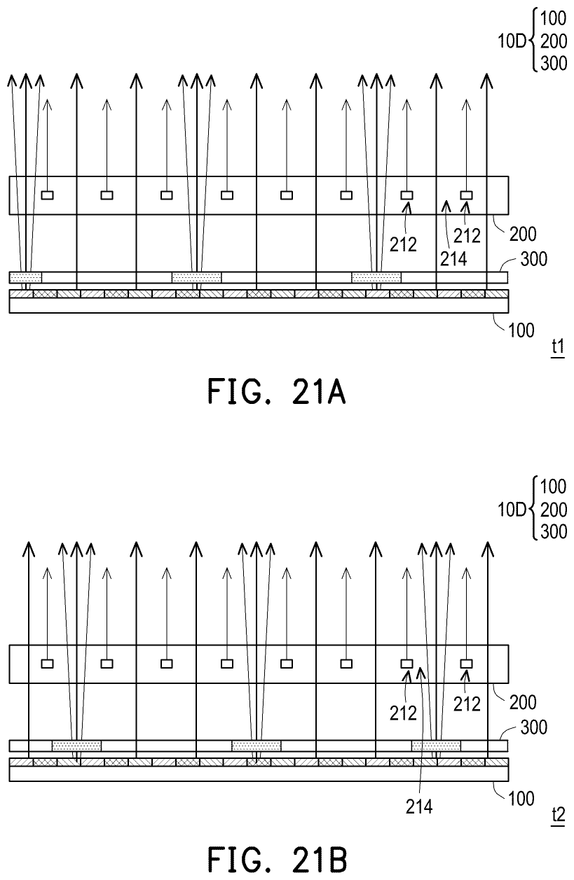

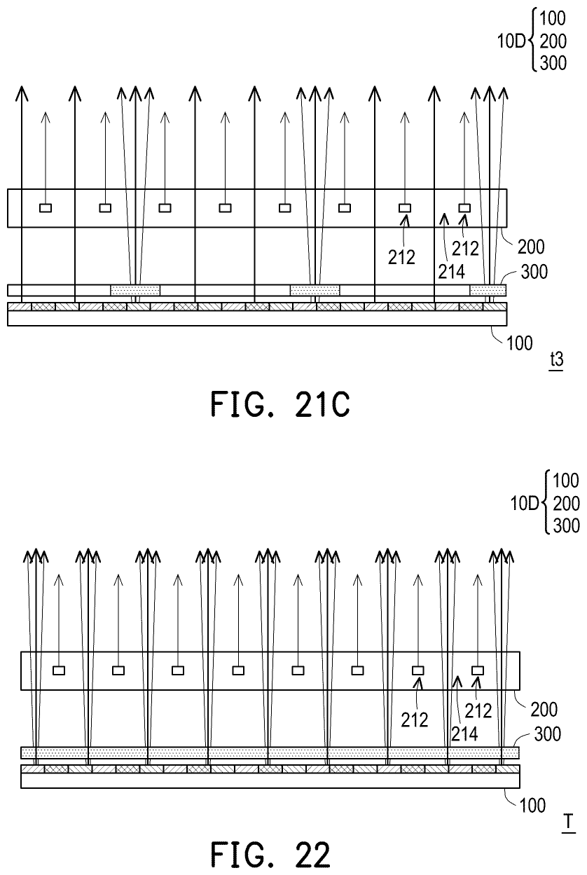

FIG. 21A to FIG. 21C are cross-sectional schematic diagrams of a display apparatus 10D according to an embodiment of the disclosure. Specifically, FIG. 21A to FIG. 21C show the operating status of the display apparatus 10D in the sub-frame times t1, t2, and t3, respectively, where the sub-frame time t1, the sub-frame time t2, and the sub-frame time t3 proceed in time sequence within the same frame time T of the display apparatus 10D. One frame time T equals the sum of the plurality of sub-frame times t1, t2, and t3. FIG. 22 is a cross-sectional schematic diagram of the display apparatus 10D according to an embodiment of the disclosure. Specifically, FIG. 22 shows the superimposed display effect of the display apparatus 10D in the plurality of sub-frame times t1, t2, and t3 (i.e., one frame time T) corresponding to FIG. 21A to FIG. 21C.

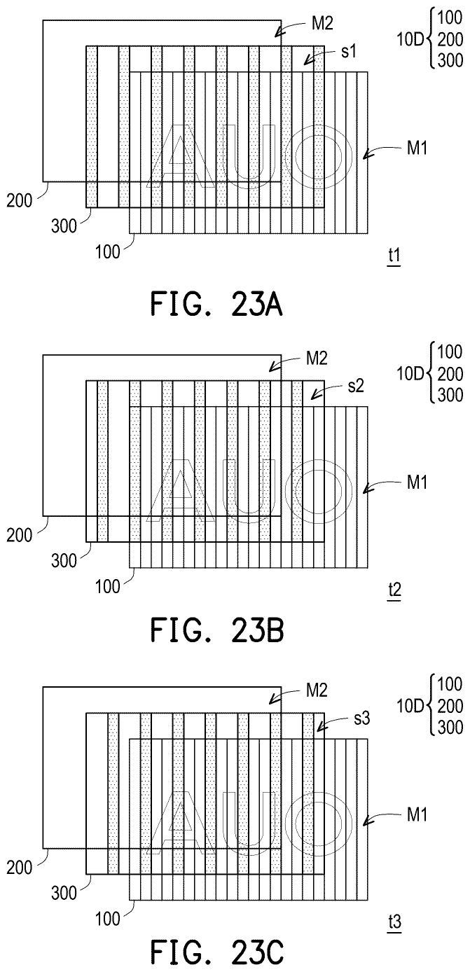

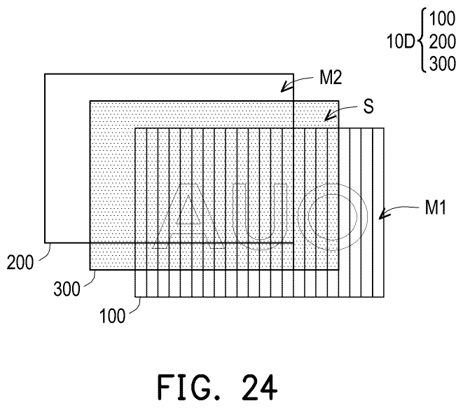

FIG. 23A to FIG. 23C are exploded three-dimensional schematic diagrams of the display apparatus 10D according to an embodiment of the disclosure. Specifically, FIG. 23A to FIG. 23C show the operating status of the display apparatus 10D in the plurality of sub-frame times t1, t2, and t3, respectively, where the sub-frame times t1, t2, and t3 proceed in time sequence within the same frame time T of the display apparatus 10D. FIG. 24 is an exploded three-dimensional schematic diagram of the display apparatus 10D according to an embodiment of the disclosure. Specifically, FIG. 24 shows the superimposed display effect of the display apparatus 10D in the plurality of sub-frame times t1, t2, and t3 (i.e., one frame time T) corresponding to FIG. 23A, FIG. 23B and FIG. 23C. FIG. 23A, FIG. 23B, FIG. 23C, and FIG. 24 correspond to FIG. 21A, FIG. 21B, FIG. 21C, and FIG. 22, respectively.

Referring to FIG. 21A to FIG. 24, the display apparatus 10D of this embodiment is similar to the aforementioned display apparatus 10, with the difference between the two being: the display apparatus 10D further includes an electronic control element 300, disposed between the transparent display panel 200 and the display panel 100. In some embodiments, each region of the electronic control element 300 may be controlled to be in a transmission status or a scattering status. For example, in some embodiments, the electronic control element 300 may be a polymer dispersed liquid crystal (PDLC) panel. The polymer dispersed liquid crystal panel may include two light-transmitting substrates (not shown), a polymer dispersed liquid crystal layer (not shown) disposed between the two light-transmitting substrates, a patterned electrode layer (not shown) disposed between one of the light-transmitting substrates and the polymer dispersed liquid crystal layer, and a common electrode layer (not shown) disposed between the other light-transmitting substrate and the polymer dispersed liquid crystal layer. By controlling the voltage difference between the patterned electrode layer and the common electrode layer, each region of the electronic control element 300 may be controlled to be in a transmission status or a scattering status. For example, the patterned electrode layer of the polymer dispersed liquid crystal panel may include a plurality of control electrodes; if a voltage difference exists between a control electrode and the common electrode layer, the region where this control electrode is located may be in a transmission status; if substantially no voltage difference exists between a control electrode and the common electrode layer, the region where this control electrode is located may be in a scattering status. However, the disclosure is not limited thereto, in other embodiments, the electronic control element 300 may also be other types of elements, such as but not limited to: a liquid crystal panel with ions mixed in its liquid crystal layer, a cholesteric liquid crystal panel, etc.

Referring to FIG. 21A to FIG. 21C, FIG. 22, FIG. 23A to FIG. 23C, and FIG. 24, within a frame time T of the display apparatus 10D, the display panel 100 displays a first image M1, the transparent display panel 200 displays a second image M2, the first image M1 and the second image M2 match with each other to provide a real depth image. The frame time T includes the plurality of sub-frame times t1, t2, and t3 in time sequence. The electronic control element 300 displays a plurality of scattered images s1, s2, and s3 at the plurality of sub-frame times t1, t2, and t3, respectively, and the spatial distribution of the plurality of scattered images s1, s2, and s3 in the electronic control element 300 are different from each other. Thereby, in the plurality of sub-frame times t1, t2, and t3, the difference in spatial frequency between the first image M1 of the display panel 100 and the second image M2 of the transparent display panel 200 passing through different scattered images s1, s2, and s3 of the electronic control element 300 may not be fixed, thus suppressing moiré pattern.

What is claimed is:

1. A display apparatus, comprising:
a display panel; and
a transparent display panel, disposed in front of the display panel, the display panel being separated from the transparent display panel by a distance,
wherein within a frame time of the display apparatus, the display panel displays a first image, the transparent display panel displays a second image, and the first image and the second image are matched to provide a real depth image,
the frame time comprises a plurality of sub-frame times in time sequence, the display panel displays a plurality of sub-images in the sub-frame times, respectively, the sub-images are different from each other, and the sub-images are capable of being superimposed to form the first image within the frame time.

2. The display apparatus according to claim 1, wherein each of the sub-images has a black pattern, and a plurality of black patterns of the sub-images have different spatial distributions in the display panel.

3. The display apparatus according to claim 2, wherein the black pattern comprises a plurality of black stripes separated from each other.

4. The display apparatus according to claim 3, wherein the black stripes of the black patterns of the sub-images are misaligned with each other.

5. The display apparatus according to claim 3, wherein the black stripes of the black patterns of the sub-images are a plurality of vertical black stripes.

6. The display apparatus according to claim 3, wherein the black stripes of the black patterns of the sub-images are a plurality of diagonal black stripes.

7. The display apparatus according to claim 2, wherein the black pattern comprises a plurality of black blocks, the black blocks are arranged into a plurality of black block rows, a plurality of black blocks in each of the black block rows are arranged in a first direction, the black block rows are arranged in a second direction intersecting with the first direction, and the black blocks of each of the black block rows are alternately arranged with the black blocks of a next black block row.

8. The display apparatus according to claim 7, wherein the black blocks of the sub-images are misaligned with each other.

9. A display apparatus, comprising:
a display panel; and
a transparent display panel, disposed in front of the display panel, the display panel being separated from the transparent display panel by a distance, and the distance is adjustable,
wherein within a first frame time of the display apparatus, the display panel displays a first image, the transparent display panel displays a second image, the first image and the second image are matched to provide a first real depth image, the first frame time comprises a plurality of first sub-frame times in time sequence, the display panel displays a plurality of first sub-images respectively at the first sub-frame times, the first sub-images are different from each other, and the first sub-images are capable of being superimposed to form the first image within the first frame time,
within a second frame time of the display apparatus, the display panel displays a third image, the transparent display panel displays a fourth image, the third image and the fourth image are matched to provide a second real depth image, the second frame time comprises a plurality of second sub-frame times in time sequence, the display panel displays a plurality of second sub-images respectively at the second sub-frame times, the second sub-images are different from each other, and the second sub-images are capable of being superimposed to form the third image within the second frame time,
the second frame time is before or after the first frame time, and a time length of the first frame time is substantially equal to a time length of the second frame time,
within the first frame time, the distance between the display panel and the transparent display panel is a first distance,
within the second frame time, the distance between the display panel and the transparent display panel is a second distance, and the second distance is less than the first distance, and
a quantity of the second sub-images displayed by the display panel within the second frame time is greater than a quantity of the first sub-images displayed by the display panel within the first frame time.

10. The display apparatus according to claim 9, wherein each of the first sub-images has a black pattern, and a plurality of black patterns of the first sub-images have different spatial distributions in the display panel.

11. The display apparatus according to claim 10, wherein the black pattern comprises a plurality of black stripes separated from each other.

12. The display apparatus according to claim 11, wherein the black stripes of the black patterns of the first sub-images are misaligned with each other.

13. The display apparatus according to claim 11, wherein the black stripes are a plurality of vertical black stripes.

14. A display apparatus, comprising:
a display panel;
a transparent display panel, disposed in front of the display panel, the display panel being separated from the transparent display panel by a distance; and
an electronic control element, disposed between the transparent display panel and the display panel,
wherein within a frame time of the display apparatus, the display panel displays a first image, the transparent display panel displays a second image, and the first image and the second image are matched to provide a real depth image,
the frame time comprises a plurality of sub-frame times in time sequence, the electronic control element displays a plurality of scattered images at the sub-frame times, respectively, and the scattered images have different spatial distributions in the electronic control element.

15. The display apparatus according to claim 14, wherein each region of the electronic control element is controllable to be in a transmission status or a scattering status.
